(19) United States
(12) Patent Application Publication
(10) Pub. No.: US 2016/0207802 A1
(43) Pub. Date: Jul. 21, 2016

(54) SYSTEM FOR SEPARATING SOLIDS FROM A LIQUID WASTE STREAM

(71) Applicants: Douglas G. Pullman, Watford (CA); Roger H. Woods, Watford (CA)

(72) Inventors: Douglas G. Pullman, Watford (CA); Roger H. Woods, Watford (CA)

(21) Appl. No.: 14/996,458

(22) Filed: Jan. 15, 2016

Related U.S. Application Data
(60) Provisional application No. 62/104,180, filed on Jan. 16, 2015.

(51) Int. Cl. C02F 1/52; B01D 21/00; B01D 29/11; B01D 21/24; C02F 1/00; B01D 21/01

(52) U.S. Cl. CPC C02F 1/52; C02F 1/004; B01D 21/01; B01D 29/11; B01D 21/2405; B01D 21/0018; C02F 2103/10

(57) ABSTRACT

A liquid waste cleaning station for removing solids is described. The station comprises at least one pump for pumping liquid waste through the station. A floc-delivery module is provided, in fluid communication with the at least one pump for preparing and metering into the liquid waste a selected quantity of flocculent material. A blender in fluid communication with the floc-delivery module subjects the mixture of liquid waste and flocculent material to both mixing action and time to promote flocculation. A filtering device in fluid communication with the blender provides a pore size suitable for retaining formed floc, thereby removing it from the separated water portion. A liquid waste cleaning process to remove solids is also described.

### CROSS-REFERENCE TO RELATED APPLICATION

The present application claims the benefit of U.S. Provisional Appl. No. 62/104,180, filed Jan. 16, 2015, the entirety of which is incorporated by reference herein.

### FIELD OF THE INVENTION

The present invention relates to the field of drilling, and in particular to a process and apparatus for cleaning waste drilling fluid arising from rock drilling applications.

### BACKGROUND OF THE INVENTION

Creating wellbores into the earth, in particular where the wellbore must pass through rock has many challenges. Such wellbores may be prepared to facilitate extraction of a variety of natural resources, ranging from oil and gas to fresh water.

When drilling through rock, the drilling industry implements a variety of specialized tools and technologies. Of particular concern during rock drilling is the management of the downhole drill bit, for example to ensure the bit is adequately cooled and lubricated. It is also necessary to suspend and remove the grindings and particulates, as they can interfere with and bog down the cutting action. Managing these issues is generally achieved through the use of drilling fluids.

In some applications, drilling fluids are comprised of only water. In these circumstances, normal practice has been to separate the cuttings or particulates from the drilling fluid by allowing them to settle out by gravity in multiple tanks. This takes considerable time and requires a large footprint of tanks where space may be at a premium. Accordingly, specialized drilling fluid cleaners are desired in the industry to perform a more active approach to cleaning, preferably in a shortened time frame from current apparatus and methods.

### SUMMARY OF THE INVENTION

According to an aspect of an embodiment, a liquid waste cleaning station for removing solids is provided herein. The station comprises at least one pump for pumping liquid waste through the station. A floc-delivery module is provided, in fluid communication with the at least one pump for preparing and metering into the liquid waste a selected quantity of flocculent material. A blender in fluid communication with the floc-delivery module subjects the mixture of liquid waste and flocculent material to both mixing action and time to promote flocculation. A filtering device in fluid communication with the blender provides a pore size suitable for retaining formed floc, thereby removing it from the separated water portion.

According to another aspect of an embodiment, a process for cleaning liquid waste is provided herein. The process comprises pumping a liquid waste from a sump or pit into a cleaning station, adding a dry flocculent material to the liquid waste, and subjecting the liquid waste with the flocculent material to a hammering or pulsation effect. The liquid waste is mixed with the flocculent material to promote floc formation after which the floc is separated from the liquid waste to produce cleaned water. The collected cleaned water may be re-used.

According to a further aspect of an embodiment, a process for cleaning waste drilling fluid is provided herein. The process includes pumping waste drilling fluid from a sump or pit into a cleaning station, adding a dry flocculent material to the waste drilling fluid and providing a hammering or pulsation effect to the mixture of the flocculent material and waste drilling fluid. The waste drilling fluid is mixed with the dry flocculent material to promote floc formation, after which the floc is separated from the waste drilling fluid to provide or produce cleaned water. The cleaned water may then be collected and re-used in drilling operations.

### BRIEF DESCRIPTION OF FIGURE

The foregoing and other features and advantages of the invention will be apparent from the following description of embodiments hereof as illustrated in the accompanying drawing. The accompanying drawings, which are incorporated herein and forms a part of the specification, further serves to explain the principles of the invention and to enable a person skilled in the pertinent art to make and use the invention. The drawing is not to scale.

FIG. 1 is a schematic illustration of a cleaning station for cleaning spent or waste drilling fluid arising from rock drilling operations in accordance with an embodiment hereof.

FIG. 2 is a schematic illustration of the cleaning station of FIG. 1 with an additional separator-settling unit incorporated therein.

### DETAILED DESCRIPTION

The following detailed description is merely exemplary in nature and is not intended to limit the invention or the application and uses of the invention. A person skilled in the relevant art will recognize that other configurations and arrangements can be used without departing from the scope of the invention. Although the description and drawings of the embodiments hereof exemplify the technology in relation to rock drilling, the invention may also be used in other drilling technologies where drilling fluids are used. The invention may also find application in respect of other waste streams arising from sources outside of drilling, including but not limited to industrial, food and agricultural liquid wastes. Furthermore, there is no intention to be bound by any expressed or implied theory presented in the preceding technical field, background, brief summary, or the following detailed description.

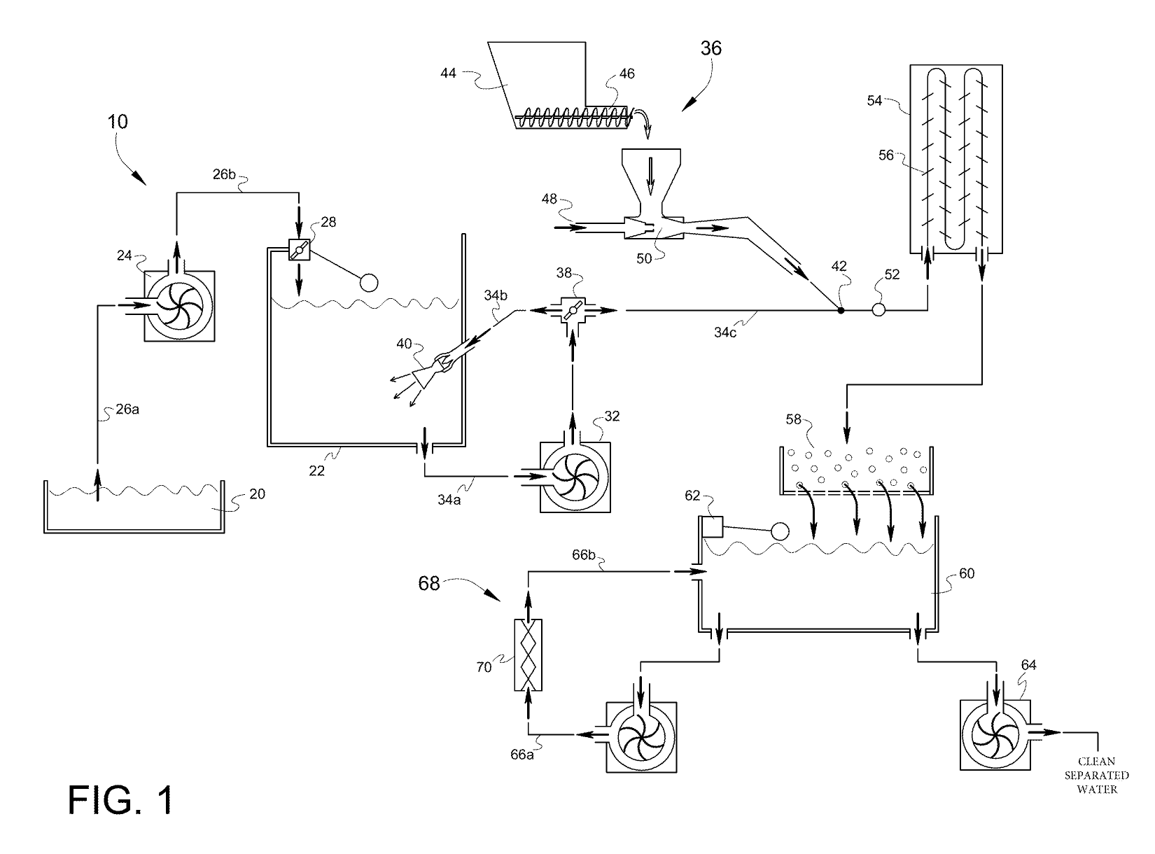

Referring to FIG. 1, there is schematically illustrated a cleaning station 10 for cleaning spent or waste drilling fluid arising from rock drilling operations. In a standard drilling operation, waste drilling fluid contaminated with particulate matter is generally collected and directed to a suitable reservoir or pit 20 for temporary storage. Waste drilling fluid is then pumped from pit 20 into storage tank 22 via first pump 24, drawing or directing waste drilling fluid through delivery conduits 26a, 26b. Operation of first pump 24 and flow of waste drilling fluid through conduits 26a, 26b may be controlled manually, or may be governed by a suitable control device, for example a float switch 28 situated on storage tank 22. It will be appreciated that first pump 24 may take on a variety of forms including, but not limited to a diaphragm pump, a centrifugal pump, a piston pump or a gear pump, or any other type of apparatus designed to move fluid.

The waste drilling fluid is then pumped from storage tank 22 via second pump 32, directing waste drilling fluid through delivery conduit 34a towards floc-delivery module 36. Prior to floc-delivery module 36, at least a portion of the waste drilling fluid may be redirected back to storage tank 22 via valve 38 and delivery conduit 34b, to promote mixing and suspension of any settled material in storage tank 22. Mixing and suspension at storage tank 22 may be enhanced or facilitated through the use of a suitable nozzle(s) 40 provided on the outlet of delivery conduit 34b. Downstream of valve 38, along delivery conduit 34c, the waste drilling fluid receives at inlet 42 a suitable flocculent additive from floc-delivery module 36.

Floc-delivery module 36 prepares a flocculent material for delivery into the waste drilling fluid at inlet 42. Floc-delivery module 36 comprises a hopper 44 for receiving flocculent material in bulk, a suitable metering device 46 for dispensing a selected quantity of flocculent material, a compressed air inlet 48 for receiving compressed air from a compressed air source, such as an air compressor (not shown), and a compressed air driven venturi 50 for delivery of the metered quantity of flocculent material into the waste drilling fluid at inlet 42. Compressed air driven venturi 50 supplies a force of air flow sufficient to drive the air and flocculent mix into the waste drilling fluid at inlet 42, and downstream into blender 54. Inlet 42 may be positioned at an angle, as shown schematically in FIG. 1, to further promote downstream flow. The use of air driven venturi 50 also serves to add air pockets or gaps into the waste drilling fluid which may aid in the mixing and/or separation action within blender 54. In some embodiments, delivery conduit 34c may additionally comprise a check valve 52. Control of the ratio of flocculent material to waste drilling fluid may be achieved by controlling the flow of waste drilling fluid through delivery conduit 34c by virtue of valve 38. For a given metered quantity of flocculent material, an increased floc-to-waste ratio may be achieved by decreasing the flow of waste drilling fluid through delivery conduit 34c, thereby increasing the flow through delivery conduit 34b back to storage tank 22. Conversely, a decreased floc-to-waste ratio may be achieved by increasing the flow of waste drilling fluid through delivery conduit 34c thereby decreasing the flow through delivery conduit 34b back to storage tank 22. It will be appreciated that a targeted floc-to-waste ratio may be achieved by adjusting both the waste drilling fluid flow rate through delivery conduit 34c, and the metered quantity of flocculent material being delivered at inlet 42.

The apparatus and process described above is generally for use with dry flocculants provided in either powdered or granular form. Dry flocculants have the advantage of reduced cost of production, easier transport and storage, they are generally stronger and more concentrated than a diluted liquid form, and they have a longer “shelf life” compared to liquid forms. It will be appreciated however, that in certain applications, liquid flocculants may be suitably implemented through a suitable liquid flocculent delivery mechanism.

After addition of flocculent material at inlet 42, the waste drilling fluid is directed to blender 54 to promote flocculation. When using a dry flocculent and mixing it into the waste drilling fluid, the dry additives in the flocculent require sufficient time to hydrate and become soluble to mix into the fluid. They also require time to activate or change the components of the fluid (i.e. the cuttings or grindings present as suspended solids), then gather together to form larger floc particles having weight greater than the water portion. The formed floc generally falls to the bottom as a collection of solid particles, thereby separating from the water. In the present embodiment, blender 54 is provided in the form of a static mixer, generally comprising a pipe or conduit having a static helix or spiral baffle-like structure 56 situated therein. Blender 54 subjects the treated waste material to gentle mixing to promote floc formation.

Action within blender 54 may be additionally enhanced by subjecting the combination of the flocculent material and waste drilling fluid to a hammering or pulsation effect. For example, in one embodiment, to introduce a hammering or pulsation effect into the combination of flocculent and waste drilling fluid, second pump 32 is provided in the form of a diaphragm or piston-type pump. It will be appreciated, however, that other means to introduce a hammering or pulsation effect may be implemented, for instance, a spring loaded (open and close) valve, either as part of second pump 32 or as an additional component, for example provided on delivery conduit 34c. As the waste drilling fluid proceeds through blender 54, the pulsation or hammer effect intensifies the mixing action upon the helix structures 56, while the zones between the helix structures 56 permit for floc formation. The addition of air from compressed air venturi 50 may further enhance the mixing action.

Exiting blender 54, the treated waste drilling fluid is directed to a filtering device 58, for example a perforated media filter basket, provided with a pore sizing sufficient to retain the formed floc structures, while allowing the separated water portion to pass through and collect in holding tank 60. Holding tank 60 may incorporate the use of a float switch 62, to control second pump 32 and prevent overflow. The cleaned separated water may then be pumped back to the drill rig for reuse in preparing the drilling fluid, via third pump 64. Third pump 64 is generally a high pressure pump, but it will be appreciated that other types of pumps may be implemented here as the water for re-use is largely clean and free of large particulates. It will be appreciated that the use of a perforated media filter basket is exemplary and that other filtering devices may be used, including but not limited to a canister-type bag filter, a rotating screening drum, a filter press, a media cloth conveyor belt, and a centrifuge unit.

The cleaned water collected in holding tank 60 may also be implemented in closed loop or zero discharge processes at the drill site. For example, a closed-loop system 68 in FIG. 1 receives the clean water from holding tank 60 via delivery conduit 66a, processes the clean water through a heat exchanger 70 to cool a drilling rig's hydraulic system, and returns the warmed clean water back to holding tank 60 via delivery conduit 66b. Since the water is clean, it will not have a tendency to plug the internal fluid path of the heat exchanger. The water in tank 60 may also be used as clean-up or wash down water for the work area, tooling, and equipment. After use this water can then be routed or directed back to the pit 20, and subject to cleaning as described above.

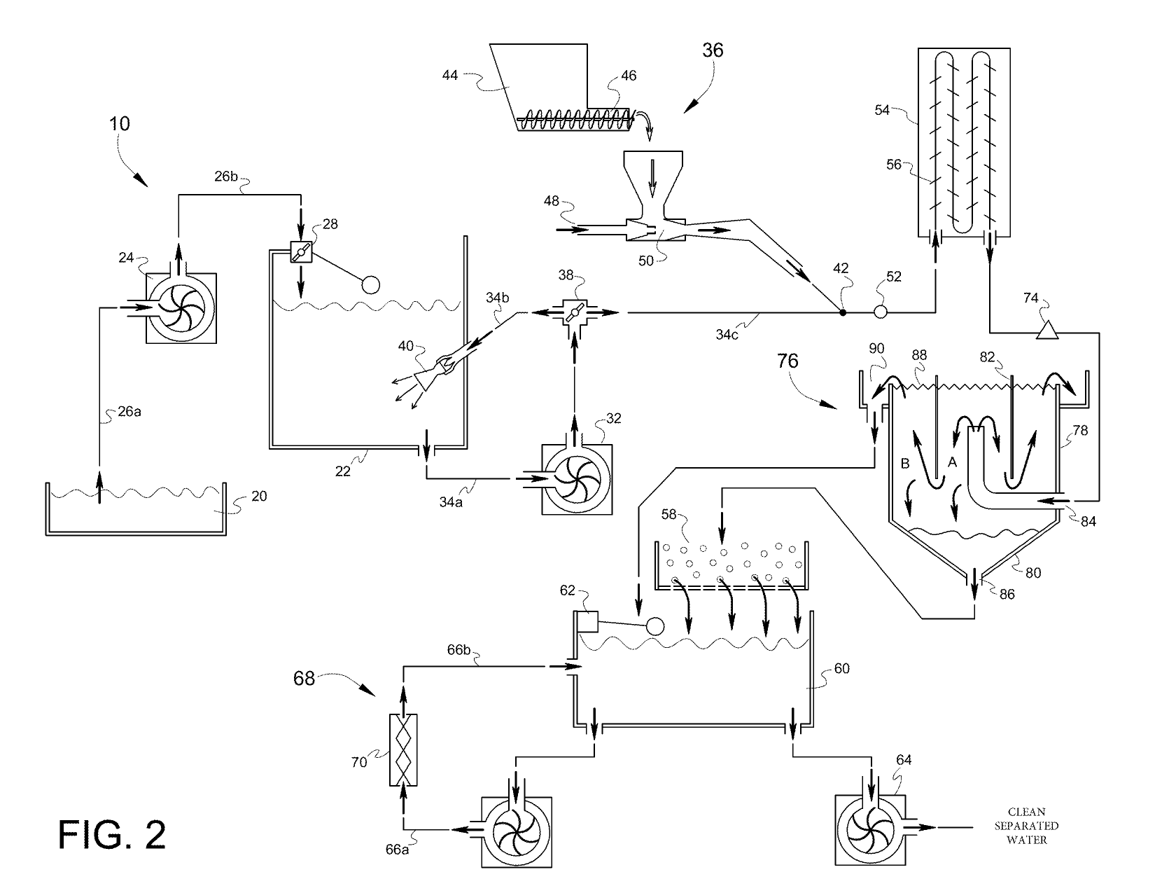

In some embodiments, cleaning station 10 may comprise other system components to enhance the separation of the formed floc structures from the waste drilling fluid. As shown schematically in FIG. 2, cleaning station 10 may additionally comprise a suitable separator-settling unit 76 between blender 54 and filtering device 58. To facilitate air removal if necessary, an air removal valve 74 may additionally be incorporated prior to separator-settler unit 76.

As presented, separator-settling unit 76 is presented in the form of a radial flow separator. A radial flow separator generally comprises a reservoir 78 having a conical or tapered bottom 80, an inner cylindrical divider 82, an inlet conduit 84, a solids collection outlet 86, and a liquids collection trough 90. In the configuration shown, divider 82 is positioned within reservoir 78, concentrically aligned thereto. Accordingly, divider 82 establishes two separated regions within separator-settling unit 76, namely region A within the area of divider 82, and region B, the annular area between the wall structures of divider 82 and reservoir 78. Separator-settler 76 directs an incoming liquid stream in a first upwardly direction via inlet conduit 84 into region A. As the upper wall of divider 82 is higher than the uppermost level of liquid in reservoir 78, liquid exiting inlet conduit 84 is redirected downwardly, again keeping within region A of divider 82. As divider 82 is raised from bottom 80, which is kept in spaced-apart relationship therefrom, heavier solids (i.e. the formed floc structures) fall out of the liquid stream, collecting at bottom 80. Cleaner liquid flows around the lower region of divider 82 into region B, redirecting upwardly and exiting over upper wall 88. The cleaner liquid is collected in trough 90, and directed to holding tank 60.

The solids, i.e. the formed floc structures, collected at the bottom of separator-settling unit 76 are released to filtering device 58 for further separation of the solids and separable water content.

The various components making up cleaning station 10 may be assembled on a single frame or platform structure, in particular to facilitate transport. It will be appreciated, however, that the various components may be separately arranged and interconnected through suitable piping to achieve the aforementioned delivery conduits throughout the station.

It will be appreciated that while presented above in a generally continuous flow configuration, the process and apparatus may find application in certain instances in a batch flow configuration.

It will be appreciated that, although embodiments of the invention have been described and illustrated in detail, various modifications and changes may be made. While preferred embodiments are described above, some of the features described above can be replaced or even omitted. Still further alternatives and modifications may occur to those skilled in the art. All such alternatives and modifications are believed to be within the scope of the invention.

What is claimed is:

1. A liquid waste cleaning station for removing solids, the station comprising:
at least one pump for pumping liquid waste through the station;
a floc-delivery module in fluid communication with the at least one pump for preparing and metering into the liquid waste a selected quantity of flocculent material;
a blender in fluid communication with the floc-delivery module, the blender subjecting the mixture of liquid waste and flocculent material to both mixing action and time to promote flocculation;
a filtering device in fluid communication with the blender, the filtering device having a pore size suitable for retaining formed floc, thereby removing it from the separated water portion.

2. The liquid waste cleaning station according to claim 1, wherein the at least one pump is one of a diaphragm pump and a piston pump configured to receive liquid waste from a waste liquid storage tank.

3. The liquid waste cleaning station according to claim 1, wherein the floc-delivery module comprises an air driven venturi to force an air and flocculent mixture into the liquid waste.

4. The liquid waste cleaning station according to claim 3, wherein the floc-delivery module further comprises a flocculent hopper and a metering device to deliver the select quantity of flocculent material to the air driven venturi.

5. The liquid waste cleaning station according to claim 1, wherein the blender is provided in the form of a static mixer having a static helix or spiral baffle-like structure contained within one of a pipe or a conduit.

6. The liquid waste cleaning station according to claim 1, wherein at least one component in the station subjects the liquid waste to one of a hammering effect or a pulsation effect to promote flocculation in the blender.

7. The liquid waste cleaning station according to claim 2, wherein the one of a diaphragm pump and a piston pump is configured to subject the liquid waste to one of a hammering effect and a pulsation effect to promote flocculation in the blender.

8. The liquid waste cleaning station according to claim 1, further comprising:
a spring loaded valve operated so as to subject the liquid waste to one of a hammering effect and a pulsation effect to promote flocculation in the blender.

9. The liquid waste cleaning station according to claim 1, wherein the filtering device is a perforated media filter basket.

10. The liquid waste cleaning station according to claim 1, further comprising:
a separator-settling unit in fluid communication with and situated between the floc-delivery module and the blender.

11. The liquid waste cleaning station according to claim 10, wherein the separator-settling unit is presented in the form of a radial flow separator.

12. The liquid waste cleaning station according to claim 10, wherein suspended solids collected as floc in the radial flow separator are directed to the filtering device for further separation of the solids and separable water content.

13. A process for cleaning liquid waste, the process comprising:
pumping a liquid waste from a sump or a pit into a cleaning station;
adding a dry flocculent material to the liquid waste;
subjecting the liquid waste with the flocculent material to one of a hammering effect and a pulsation effect;
mixing the liquid waste with the flocculent material to promote floc formation;
separating floc from the liquid waste to produce cleaned water; and
collecting the cleaned water for re-use.

14. The process for cleaning liquid waste according to claim 13, wherein the dry flocculent material is added to the liquid waste through an air-driven venturi to promote the incorporation of air into the liquid waste.

15. A process for cleaning waste drilling fluid, the process comprising:
pumping a waste drilling fluid from a sump or a pit into a cleaning station;
adding a dry flocculent material to the waste drilling fluid;
subjecting the waste drilling fluid with the flocculent material to one of a hammering effect and a pulsation effect;
mixing the waste drilling fluid with the flocculent material to promote floc formation;
separating floc from the waste drilling fluid to produce cleaned water; and
collecting the cleaned water for re-use in drilling operations.
